(19) United States
(12) Patent Application Publication
(10) Pub. No.: US 2026/0178188 A1
(43) Pub. Date: Jun. 25, 2026

(54) EDGE SWIPE TRIGGER FOR TOUCH DISPLAYS ON ELECTRONIC DEVICE

(71) Applicant: Datalogic IP Tech S.r.l., Lippo di Calderara di Reno (Bologna) (IT)

(72) Inventors: Marco LI, Shenzhen (CN); Lucas DENG, Shenzhen (CN)

(21) Appl. No.: 19/000,480

(22) Filed: Dec. 23, 2024

(51) Int. Cl. G06F 3/04883

(52) U.S. Cl. CPC G06F 3/04883

(57) ABSTRACT

A portable electronic device having a touch screen with one or more defined edge trigger regions for enabling various functions of the electronic device, such as data capture and other data reading modes. The edge trigger regions may be displayed adjacent one or more peripheral edges of the touch screen to enable easy identification and access for the user. In operation, the user may apply a control gesture along the edge trigger regions on the touch screen to configure and/or operate the electronic device as desired. The operation, appearance, and functionality of the edge trigger regions may be programmable to customize operation of the device for specific uses and environments.

### BACKGROUND

The field of the disclosure relates generally to systems and methods for capturing and reading data using an electronic device. More particularly, the field of the disclosure relates to such electronic devices having a touch screen interface for enabling and configuring modes and functions of the electronic device, including for example, functionality for reading optical data and configuring other suitable features of the electronic device.

Optical reading systems are widely used to read data in the form of optical codes or other encoded symbols printed on various objects. These systems may be used in a wide variety of applications, such as inventory control and point-of-sale transactions in retail stores. Barcodes are just one example of the many types of optical codes in use today. The most common barcodes are one-dimensional or linear optical codes, where the information is encoded in one direction—the direction perpendicular to the bars and spaces. For example, one-dimensional (1D) barcode symbologies may include Code 128, Code 29, Interleaved 2 of 5, matrix 2 of 5, Universal Product Code (UPC), Extended Code 39, Code 93, UCC 128, Codabar, EAN/JAN, MSI, Zip+4, Pharmacode 39, RSS, Standard 2 of 5, Trioptic, DPBC POSTNET. Higher-dimensional optical codes, such as, two-dimensional matrix codes (e.g., MaxiCode) or stacked codes (e.g., PDF 417), which are also sometimes referred to as “two-dimensional barcodes,” are also used for various purposes. Based on the type of barcode label that is being used, an appropriate set of decoding parameters is used to accurately read and process the data.

Typically, a one-dimensional barcode label comprises a series of parallel dark bars of varying widths with intervening light spaces, also of varying widths. The information encoded in the barcode label is represented by the specific sequence of bar and space widths. Optical reading systems may employ an optical reader that illuminates the barcode label and detects light reflected from the bars and spaces of the code. One common optical reader is a flying spot scanner in which a source of illumination, such as a laser or LED, is moved across the barcode while a photodetector in the optical reader monitors the reflected or backscattered light. After the barcode data is received by the optical reader, the optical reader may decode and process the barcode data and store it or transmit it to another device for storage.

Another type of data reader is an imaging reader such as a CCD (charge coupled device) or CMOS (complimentary metal oxide semiconductor) in which an entire line of the barcode image or a two-dimensional image of a scan region is focused onto a detector array. The imaging reader typically includes a light source to illuminate the barcode to provide the required signal response. Once the signal has been received for the entire read region, it may be processed and decoded.

Yet another type of data reader does not use optical barcodes, but instead reads electronic tags using radio waves, such as a radio-frequency identification (RFID) reader. An RFID system typically employs at least two components, a “transponder” or “tag” which is attached to a physical item to be identified, and a “reader” which sends an electromagnetic signal to the transponder and then detects a response. Typically, the reader emits an RF signal, which is received by the transponder, after the transponder comes within an appropriate range. In response, the transponder then sends its information via a modulated RF signal back to the reader. The reader detects this modulated signal, and can identify the transponder by decoding the modulated signal. After identifying the transponder, the reader can either store the decoded information or transmit the decoded signal to a computer or other device.

Currently, data reading and other electronic devices with multiple reading modes and action functions are available, where the devices are capable of capturing and decoding various types of data, such as optical barcode labels and RFID tags, and may also have other suitable functions, such as capturing images or videos, providing a screen to capture signatures, and/or enabling voice or texting options. Such electronic devices may be useful in an environment where objects may contain mixed barcode symbology and/or RFID tags, such as in a retail store or packaging facility, or where there is a need for a multi-purpose electronic device that may also capture images and videos or provide features for enabling phone calls or other functions.

In some conventional designs, such electronic devices may include one or more physical trigger buttons arranged on the housing of the device to enable, select, and/or activate various device functions as desired. In other conventional designs, electronic devices may require selection of data reading applications or may include a motion trigger (e.g., shaking a device) to activate a data reading function. The present inventors have recognized certain disadvantages of such electronic devices. For example, providing a physical trigger to activate and use the device may make handheld use of the device more challenging and/or may require the device to be used in one specific orientation due to the location of the physical trigger. In addition, the use of a physical trigger also increases the overall cost of manufacturing the device, presents a source for mechanical failure of the device, and adds to the bulk of the device, among other disadvantages.

Accordingly, the present inventors have recognized a need for a multi-purpose electronic device that allows a user to easily toggle and enable various data capture modes and functions of the device without the use of a physical trigger mechanism. In addition, the present inventors have recognized a need for such a device that is configurable to recognize unique gestures applied to a touch screen to efficiently optimize device functionality as desired. Additional aspects and advantages of these and other embodiments will be apparent from the following detailed description, which proceeds with reference to the accompanying drawings. It should be understood that the drawings depict only certain example embodiments and are not to be considered as limiting in nature.

### BRIEF DESCRIPTION OF THE DRAWINGS

FIG. 1 is a block diagram of a portable electronic device with a touch screen display in accordance with one embodiment.

FIG. 2 illustrates an example portable electronic device with a touch screen display having one or more edge trigger regions defined thereon in accordance with one embodiment.

FIG. 3 illustrates an example control gesture that may be applied along an edge trigger region to configure and initiate a data reading event via the electronic device in accordance with one embodiment.

FIG. 4 illustrates another example control gesture that may be applied along an edge trigger region to configure and initiate a data reading event of the electronic device in accordance with one embodiment.

FIG. 5 is a flow chart illustrating a method for data reading by the electronic device according to one embodiment.

### DETAILED DESCRIPTION OF EXAMPLE EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Certain embodiments may be capable of achieving various advantages, including one or more of the following: (1) providing a portable electronic device with touch screen and toggling capabilities for quickly and easily activating a data capture mode and/or initiating a data reading event to capture data from an object; (2) providing a programmable portable electronic device capable of detecting and responding to a variety of control gestures for toggling between various data capture modes and configuration settings of the device; and (3) providing a portable electronic device with an easily accessible and user-customizable activation trigger on a touch screen display.

In the following description of the figures and any example embodiments, the system may be referred to in conjunction with use at a retail establishment, such as during a checkout process of a retail store or supermarket. It should be understood that such use is merely one example use for such a system. Other uses for a system with the characteristics and features described herein may be implemented, for example, in an industrial location such as a parcel distribution station (e.g., postal, airport, etc.), parcel delivery, or for processing inventory, as well as other suitable uses. In addition, certain embodiments may refer to the portable electronic device used as a data reader operable for capturing optical codes from items. However, it should be understood that these are merely example embodiments and uses of a portable electronic device with the features and functionalities described herein. In other embodiments, the portable electronic device may be used to capture different data, such as RFID data from electronic tags or other suitable encoded data, from items or may be used in different environments or for other suitable purposes.

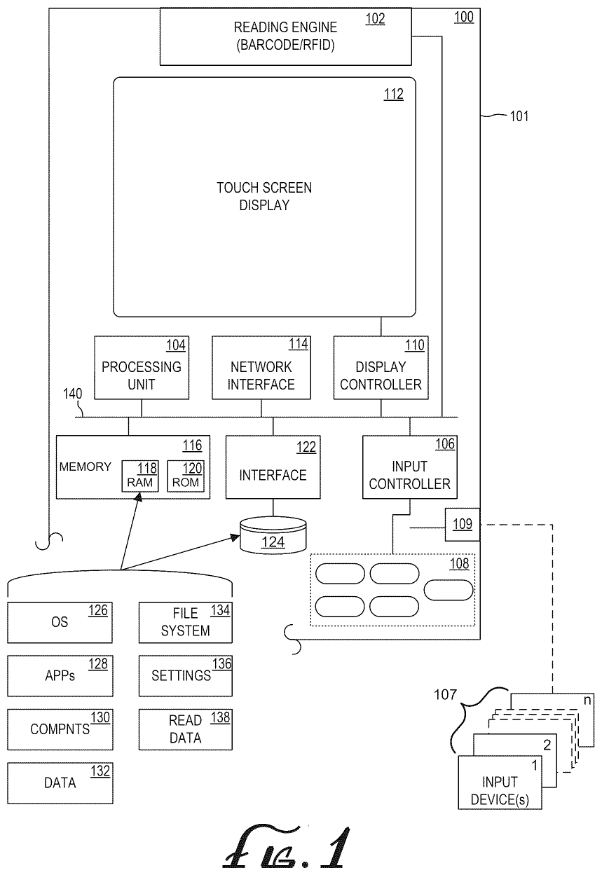

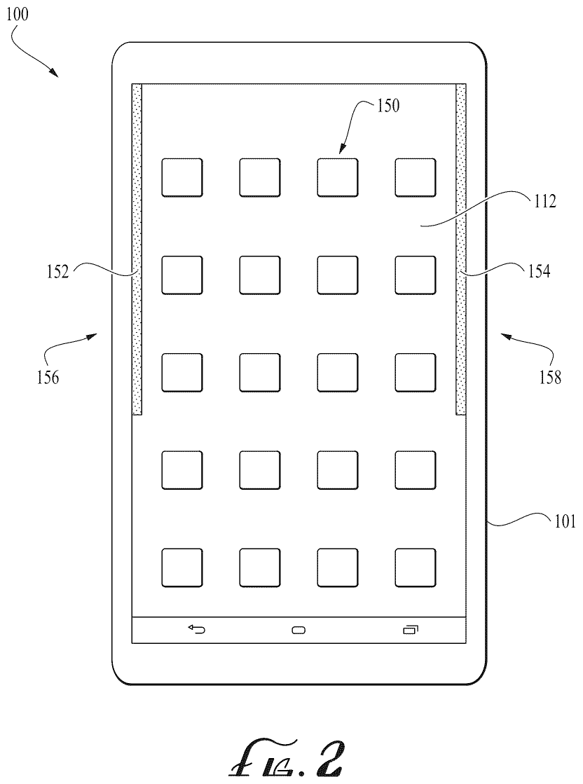

Collectively, FIGS. 1-5 illustrate various embodiments (and related methods) of a portable electronic device 100 that may be used to read and process optical data (e.g., optical barcodes), an RFID tag, or other suitable data found on an item. The portable electronic device 100 includes a touch screen 112 that may display information 150 thereon, such as application icons, images, text, or other suitable information. Along with the information 150, the touch screen 112 further includes one or more edge trigger regions 152, 154. In some embodiments, the edge trigger regions 152, 154 may overlay at least a portion of the touch screen 112. For example, with reference to FIG. 2, the edge trigger regions 152, 154 may be substantially confined along respective peripheral edges 156, 158 of the touch screen 112 adjacent the housing 101. In this example, the first edge trigger region 152 is located on a first peripheral edge 156 (e.g., a left side) of the touch screen 112 as viewed in the figures. The second edge trigger region 154 is located on a second peripheral edge 158 (e.g., a right side) of the touch screen 112. In some embodiments, additional edge trigger regions may also be located on the top and/or the bottom peripheral edges of the touch screen 112. Embodiments of the disclosure, therefore, may include edge trigger regions proximate any of the left, right, top, or bottom peripheral edges of the touch screen display 112 adjacent the housing 101, as well as any combination thereof.

As is further described in detail below with particular reference to FIGS. 2-4, a user may configure an action of the electronic device 100, such as a selected data reading mode, and/or may trigger a data reading event via the electronic device 100. To select a particular action or function associated with the electronic device 100, the operator or user may apply a control gesture along either of the edge trigger regions 152, 154 on the touch screen 112. In some embodiments, the selected action or function may differ depending on the control gesture applied and/or the edge trigger region 152, 154 at which the control gesture is applied. For example, a first data reading mode may be configured by applying a first control gesture along the edge trigger region 152 and a second data reading mode different from the first may be configured by applying a second control gesture along the edge trigger region 154. In another example, the different edge trigger regions 152, 154 may toggle different functionalities of a selected data reading mode. Once the control gesture is applied and detected by the electronic device 100, the device 100 is configured in accordance with user-defined instructions to allow the operator to perform the selected action using the electronic device 100.

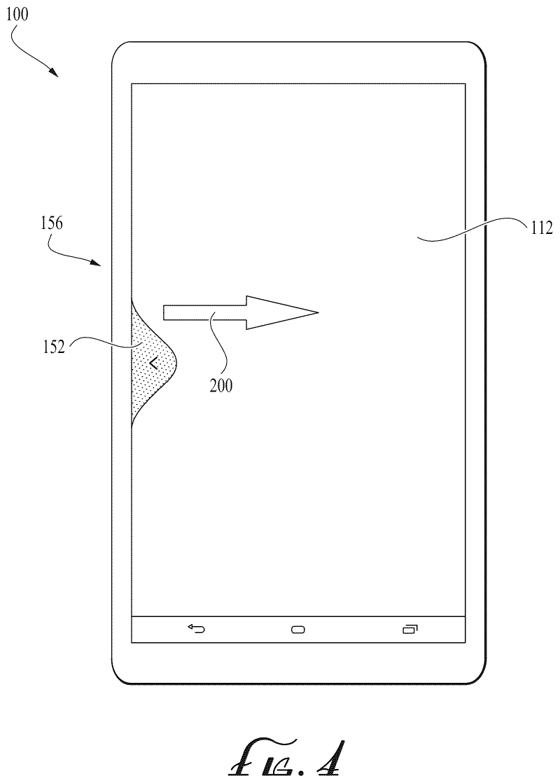

For example, in one embodiment, the operator may apply a control gesture 200 along the edge trigger region 152 (see FIG. 4) to configure or set a data reader mode of the electronic device 100. In other embodiments, another gesture may be used after the electronic device 100 has been configured to initiate a data reading process to capture data from an item. In other embodiments, different gestures may be applied as defined by a user to selectively configure the electronic device 100 as desired. Once the control gesture has been received and processed by the electronic device 100, the device 100 configures an appropriate reading engine 102 in accordance with the chosen configuration mode so that the device 100 may be used to properly capture the target data. Once the item has been processed, the user may thereafter reconfigure the device 100 to a different reader mode or a different functionality of the selected reader mode, if necessary, by applying a different control gesture. In some embodiments, only a single data reading mode may be available and the control gestures 200 applied to the edge trigger regions 152, 154 may initiate various functions (e.g., data capture, barcode reading, etc.). Control gestures 200 may include, for example, swipe gestures (e.g., left-to-right, right-to-left, top-to-bottom, bottom-to-top) depending on which area the edge trigger region 152, 154 is located. Such swipe gestures may start at a respective edge (e.g., peripheral edges 156, 158) of the touch screen 112 and move toward an inner area of the touch screen 112. The swipe gesture may be generally perpendicular to the respective starting edge in some embodiments, while other oblique lines may be used to be at more of a diagonal path from its starting position on the edge of the touch screen 112 such as a gesture starting at the left edge of the touch screen 112 moving right-downward or right-upward or a gesture starting at the right edge of the touch screen moving left-downward or left-upward. For an edge trigger region 152, 154 located on the bottom of the touch screen 112, a swipe gesture may start at the bottom of the touch screen 112 and move upward, upward-left, or upward-right. Likewise, for an edge trigger region 152, 154 located on the top of the touch screen 112, a swipe gesture may start at the top of the touch screen 112 and move downward, downward-left, or downward-right. As a result, different actions may be initiated depending on both the angle and direction of the swipe in such embodiments. In some embodiments with fewer actions, such differentiation may not be necessary and swiping in the general opposing direction may initiate a single action.

Additional control gestures 200 may also be applied for other purposes, such as a swipe and hold gesture, a press and hold gesture, a single tap, or a double tap. Additional details of these and other embodiments of the electronic device 100 are described herein with reference to the figures.

FIG. 1 illustrates a block diagram of the portable electronic device 100, such as a barcode reader, RFID reader, industrial Portable Data Terminal, mobile phone, tablet, or a multi-mode data reader (a multi-mode data reader being capable of reading optical codes, RFID tags, and other data types), according to one embodiment. With reference to FIG. 1, the electronic device 100 includes a housing 101 suitable for protecting components (as discussed in detail below) of the electronic device 100 therein and for supporting additional components, such as a keyboard 108 and a touch screen 112, on an exterior surface of the housing 101. The housing 101 is preferably compact and suited for portability and hand-held operation of the electronic device 100.

The portable electronic device 100 includes one or more reading engines 102, such as an optical label (or barcode) scanning engine, an RFID reading engine, or a multi-mode data reader capable of reading both/multiple data types. The reading engine 102 may read barcode symbols from a physical object, capture information from an RFID tag, and process captured images or other data. In some example embodiments, the reading engine 102 may include a laser barcode scan engine available from Datalogic or other manufacturers. In other embodiments, the reading engine 102 may include an RFID reading engine available from Datalogic or other manufacturers. As used herein, reading engines 102 may also encompass laser scanners, imaging scanners (such as CMOS or CCD-based imagers), cameras, and/or image sensors.

The portable data reader 100 may include a processing unit 104. The processing unit 104 may be any of various suitable commercially available processors or other logic machine capable of executing instructions. In other embodiments, suitable dual microprocessors or other multi-processor architectures may also be employed as the processing unit 104.

A standard input controller 106 may be provided to receive user input from a keyboard/keypad 108, a stylus or other pointing device (not shown), or other wired/wireless input devices. The input controller 106 may comprise a universal interface driver application specific integrated circuit (UIDA) or other suitable circuits. In some embodiments, other input devices 107 may be included, such as a microphone, digital camera, fingerprint scanner, touchpad, trackball, and tablet. While the input devices 107 may be integrated into the portable electronic device 100 and coupled to the processing unit 104 via the input controller 106, the input devices 107 may also connect via other interfaces, such as one or more connector(s) 109. The connector 109 may include one or more data interfaces, bus interfaces, wired or wireless network adapters, or modems for transmitting and receiving data. Accordingly, the input controller 106 may include one or more of hardware, software, and firmware to implement one or more protocols, such as stacked protocols along with corresponding layers, such as for example application layers (e.g., HTTP), transport layers (e.g., TCP), network layers (e.g., IP), and link layers (e.g., Ethernet). According to one embodiment, the connector 109 functions as a serial port (e.g., RS232). However, the connector 109 may also support other interfaces, such as a Universal Serial Bus (USB) port, an Ethernet port, a parallel port, an IEEE 1394 serial port, or an IR interface. The input controller 106 may also support various wired, wireless, optical, and other communication standards.

The portable electronic device 100 may present data, prompts, and otherwise communicate with a user via one or more touch screen display devices 112, such as an integrated liquid crystal display (LCD), an organic light-emitting diode (OLED), or other suitable display with touch screen capabilities. The touch screen 112 may include one or more sensors (not shown) for detecting a user's touch via a finger, stylus, or other device. A display controller 110 may drive the display device 112 and control its features.

In some embodiments, the portable electronic device 100 may further include a tilt sensor or accelerometer 142 in communication with the processing unit 104 and configured to detect whether the portable electronic device 100 has been rotated, tilted, or shaken. In some embodiments, the tilt sensor 142 may be in communication with or electronically coupled to the display controller 110 such that when the tilt sensor 142 is activated (e.g., the electronic device 100 is rotated), the display controller 110 triggers a message to display on the touch screen 112 notifying the user that the tilt sensor 142 has been activated.

The portable electronic device 100 may also include a network interface 114 to communicate with one or more other devices, such as a server, a host computer, or a point-of-sale terminal via an external network (not shown). For example, data gathered by, or decoded by, the portable electronic device 100 may be passed along to a server. The network interface 114 may facilitate wired or wireless communication with other devices over a short distance (e.g., Bluetooth™) or nearly unlimited distances (e.g., the Internet). In the case of a wired connection, a data bus may be provided using any protocol, such as IEEE 802.3 (Ethernet), advanced technology attachment (ATA), personal computer memory card international association (PCMCIA), and USB. A wireless connection may use low or high-powered electromagnetic waves to transmit data using any wireless protocol, such as Bluetooth™, IEEE 802.11b (or other WiFi standards), infrared data association (IrDa), and radio frequency identification (RFID). In addition, a modem module (not shown) or Ethernet module (not shown) may be coupled to the connector 109 to facilitate a WAN networking environment.

The portable electronic device 100 further includes a memory 116, which may be implemented using one or more standard memory devices. The memory devices may include, for instance, RAM 118, ROM 120, and EEPROM devices, and may also include magnetic or optical storage devices, such as hard disk drives, CD-ROM drives, and DVD-ROM drives. The portable electronic device 100 may also include an interface 122 coupled to an internal hard drive 124. Interface 122 may also be coupled to removable memory, such as flash memory, a magnetic floppy disk drive, an optical disk drive, or another drive. Further, the interface 122 (and/or input controller 106) may be configured for external drive implementations, such as over a USB, IEEE 1194, or PCMCIA connection.

In one embodiment, any number of program modules may be stored in one or more drives 124 and RAM 118, including an operating system 126, one or more application programs 128, other program modules 130 (such as instructions to implement the methods described herein and/or associate specific control gestures with specific functions and/or applications), data 132, file system 134, settings 136, and read data 138. All or portions of the program modules may also be cached in RAM 118. Any suitable operating system 126 may be employed, such as Windows Embedded CE, Windows Embedded Handheld, Windows Desktop, Android, Linux, iOS, MacOS, or other commercially available or proprietary operating systems capable of supporting a touch screen interface.

The memory 116, the internal hard drive 124, or both, may also store a number of settings 136 for the portable electronic device 100, which may include various symbology settings, device settings (e.g., user-interface), and network settings. Additionally, the memory 116, the internal hard drive 124, or both, may store read data 138 (e.g., symbols and information read from barcodes and RFID tags) obtained by the reading engine 102, images captured using the electronic device 100, or other data. Any of the foregoing may be stored within, or indexed by, a file system 134, which may be managed by the operating system 126.

The above-described components, including the reading engine 102, processing unit 104, input controller 106, display controller 110, network interface 114, memory 116, and interface 122, may be interconnected via a bus 140. While a bus-based architecture is illustrated in FIG. 1, other types of architectures are also suitable (e.g., one or more components may be directly coupled to one another). While the illustrated embodiment depicts one possible configuration of a portable electronic device 100, it should be recognized that a wide variety of hardware and software configurations may be provided. For example, other versions of the portable electronic device 100 may have fewer than all of these components or may contain additional components.

FIGS. 2-4 collectively illustrate various example embodiments and uses of the electronic device 100. With reference to the figures, the following discusses additional features and functions of the electronic device 100, and its example use as data reading device. In certain example embodiments, the following disclosure may associate specific control gestures with certain reading modes or other functionalities of the electronic device 100. It should be understood that the described pairing of a particular control gesture and an associated feature of the device 100 is for example purposes only and not meant to limit the scope of the disclosure. As further described in detail below, particular control gestures and corresponding functions associated with the control gesture may be programmed in a variety of configurations to facilitate user customization of the electronic device 100 as desired.

With particular reference to FIG. 2, in one example embodiment, the electronic device 100 includes a touch screen 112 that displays information 150 thereon, such as application icons, images, text, or other suitable information. Along with the information 150, the touch screen 112 may also display one or more edge trigger regions. As shown in FIG. 2, a first edge trigger region 152 is displayed along a first peripheral edge 156 (e.g., a left side) of the housing 101 and a second edge trigger region 154 is displayed along a second peripheral edge 158 (e.g., a right side) of the housing 101. As described previously, similar edge trigger regions may be displayed along a third peripheral edge (e.g., top side) and/or a fourth peripheral edge (e.g., bottom side) of the housing 101 in addition to, or instead of, edge trigger regions 152, 154 in some embodiments.

In some embodiments, the position and dimensions of the edge trigger regions 152, 154 may be defined and customized by a user in accordance with programmed instructions to optimize the device 100 for particular environments of use, a particular application, and/or user preference as desired. For example, the electronic device 100 may include an interface to allow the user to define the effective area of the edge trigger regions 152, 154 on the touch screen 112 and/or to define additional functionality relative to the edge trigger regions 152, 154 or associated gestures. In other embodiments, the position and dimensions of the edge trigger regions 152, 154 may be automatically determined by the electronic device 100. For example, in one embodiment, the dimensions of the touch screen 112 and/or the amount of information 150 displayed on the touch screen 112 may dictate the width, length, position, and/or appearance (e.g., color, shape, etc.) of the edge trigger regions 152, 154 to help ensure the edge trigger regions 152, 154 are visible and easily accessible to the user. In some embodiments, the position and dimensions of the edge trigger regions 152, 154 are substantially the same relative to one another, but the dimensions may differ in other embodiments.

As illustrated in FIG. 2, in some embodiments, the edge trigger regions 152, 154, may be visually indicated along the respective peripheral edges 156, 158 of the housing 101 of the electronic device 100. For example, in some embodiments, the edge trigger regions 152, 154 may each be displayed on the touch screen 112 as colored bordered regions along the peripheral edges 156, 158 of the housing 101 so they are easily visible by the user for applying a control gesture. The bordered regions may extend partially along the edge of the touch screen 112 in some embodiments, whereas in other embodiments, the bordered regions indicating the edge trigger regions 152, 154 may extend along the entire edge of the touch screen 112.

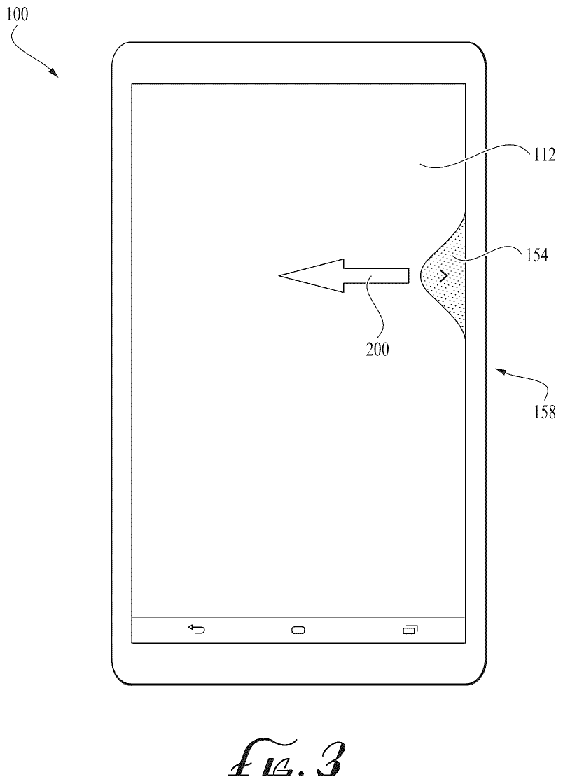

In other embodiments, the appearance of the edge trigger regions 152, 154 may take any one of a variety of suitable configurations, such as solid color sections or raised sections (see FIGS. 3-4 for example) designed to be easily visible on the touch screen 112. In some embodiments, the edge trigger regions 152, 154 are displayed with selected colors and graphics to sufficiently stand out on the touch screen 112 against any other information 150 to ensure they are easily identifiable and accessible by the operator. The appearance of the edge trigger regions 152, 154 may have a greater dimension along the edge and taper inward to indicate to the user to use a swipe gesture (or other suitable control gesture 200).

In some embodiments, the edge trigger regions 152, 154 may instead be transparent or semi-transparent as opposed to a solid color so that they only partially obscure the interface display of the touch screen 112 and allow the operator to view any underlying information 150 to facilitate operation of the device 100.

In some embodiments, the appearance and/or color of the edge trigger regions 152, 154 may change as the information 150 on the touch screen 112 changes so that the edge trigger regions 152, 154 are clearly visible on the touch screen 112. For example, the display controller 112 may determine a color and/or appearance of the edge trigger regions 152, 154 based on the primary color(s) and/or appearance(s) of the information 150 displayed on the screen 112. If the information 150 is primarily displayed in brighter colors, the display controller 112 may select a darker color for the edge trigger regions 152, 154 or vice versa. In other embodiments, the display controller 112 may limit or restrict the color(s) and/or appearance(s) of the icons and other information 150 on the screen 112 to carve out specific colors/appearances for the edge trigger regions 152, 154. In other embodiments, visual characteristics of the edge trigger regions 152, 154 may be selected and customized by the user.

In still other embodiments, the edge trigger regions 152, 154 may be defined along the first peripheral edge 156 and the second peripheral edge 158 as described previously but may not be displayed on the touch screen 112 or may not be otherwise visible to a user to avoid obscuring other information 150 on the touch screen 112. In such embodiments, the location and dimensions of the edge trigger regions 152, 154 may still be defined and customized by a user as described previously.

As described previously, the edge trigger regions 152, 154 (whether or not visibly displayed on the touch screen 112) each provide an access point for allowing the operator to configure the electronic device 100 with a selected data reading mode and/or initiate a data reading event. The following section describes an example operation of the electronic device 100 used in a data reading environment to capture an optical code from an item being processed in accordance with one example embodiment. As noted earlier, it should be understood that such data reading functions are only one example use for the electronic device 100 with the features and characteristics described herein.

With collective reference to FIGS. 3 and 4, a user may apply a control gesture 200 along one of the edge trigger regions (e.g., edge trigger region 154) to configure an action (e.g., select a particular data reading mode, initiate a data read or scan, or configure a desired functionality of a data reading mode) of the electronic device 100. As illustrated in the figures, a user may apply a swipe gesture 200 from right-to-left along the touch screen 112 (see FIG. 3) or apply a swipe gesture 200 from left-to-right along the touch screen 112 (see FIG. 4) in one example embodiment. As noted above, swipe gestures from top-to-bottom or bottom-to-top may be applied for edge trigger regions 152, 154 located along top or bottom regions, respectively. Likewise, swipe gestures in a perpendicular line or oblique line may initiate different actions in some embodiments, whereas in other embodiments such differentiation may not be desired.

With reference to FIG. 3, the selected control gesture 200 may begin at or along the edge trigger region 154 to indicate to the electronic device 100 that the user intends for the control gesture 200 to configure an action, such as a data reading mode, associated with the electronic device 100. For example, in one embodiment, the control gesture 200 illustrated in FIG. 3 may configure the electronic device 100 with a data reading mode associated with obtaining and reading optical codes from an item (not shown) being processed. Once the data reading mode has been selected and the electronic device 100 is configured with the associated reading engine 102 (or other suitable functionality), the device 100 may be used to capture data from the item being processed using the selected feature(s) (e.g., the reading engine 102) associated with the applied control gesture 200. In some embodiments, the same or different control gesture 200 may be again applied along the edge trigger region 154 to initiate a reading functionality of the electronic device 100 and capture data from the item.

In other embodiments, the data reading mode of the electronic device 100 may be configured via other methods, such as a via a user-selectable menu, or the electronic device 100 may be preset with one data reading mode. In such embodiments, the control gesture 200 may be applied to the edge trigger region 152, 154 on the touch screen 112 to initiate a data reading event to capture data from an item being processed. For example, with reference to FIG. 3, the control gesture 200 may be applied as a swipe across the edge trigger region 154 from right-to-left across the touch screen 112 to initiate a scan of an item.

In some embodiments, the electronic device 100 may also be configured to distinguish different functionality based on the control gesture 200 applied to the touch screen 112. For example, in one embodiment, the control gesture 200 may be a short swipe that may include a finger swipe from either the left or right peripheral edge 156, 158 inwardly toward a central portion of the touch screen 112 and then a release of contact with the touch screen 112. In an example embodiment, for a short swipe (also referred to as “swipe and flick”), the duration of the touch on the touch screen 112 may be equal to or less than 1 second, and the swipe distance of the touch across the touch screen 112 may be equal to or less than half of the width of the touch screen 112. In other embodiments, the touch duration and swipe distance may be set to other suitable ranges as desired. Upon receiving this control gesture 200, the electronic device 100 triggers a data reading event or scan event until a predetermined or programmed default time has elapsed. For example, the electronic device 100 may begin and continue a data read or scan event until a five-second timeout period has elapsed based on application of the control gesture 200.

As another example, a control gesture 200 consisting of a swipe-and-press action (also referred to as “long press” or “swipe and hold”) where the user maintains a finger on the touch screen 112 for a duration greater than a threshold value (e.g., greater than 1 second) after swiping inwardly from either the left or right peripheral edge 156, 158 toward the central portion of the touch screen 112. Detecting this particular control gesture 200 may trigger continuous scanning events that proceed until the touch (e.g., via a finger, stylus, or other suitable device) is released from the touch screen 112. Such a swipe-and-press action that initiates continuous scanning events until the touch is released may enable the user to better aim the electronic device 100 while reading the optical code before releasing the finger.

In still other examples, the electronic device 100 may default to a different data reading mode where the data read or scan event continues until another control gesture is applied (e.g., a finger swipe upwardly on the touch screen 112). In some embodiments, the electronic device 100 may default to this continuous operation mode unless a short swipe as described above is applied and registered.

In some embodiments, once the data reading functionality has been selected and the electronic device 100 configured accordingly, the color and/or digital appearance of the edge trigger regions 152, 154 may be altered on the touch screen 112 to visually indicate the selected device functionality to the operator. For example, the edge trigger regions 152, 154 may be a first color when a first reading functionality (e.g., an optical code reading mode) is selected, and a second color when a second reading functionality (e.g., RFID tag reading mode) is selected. Alternatively, or in addition, a color and/or appearance of the edge trigger regions 152, 154 may be altered to indicate to the user that the electronic device 100 is configured and ready to be initiated for a data reading event or scan.

In some embodiments, the edge trigger regions 152, 154 may be selectively activated to configure the electronic device 100 when the electronic device 100 is arranged in a particular orientation. For example, when the electronic device 100 is in a first orientation (e.g., a portrait layout as shown in FIGS. 2-4), the edge trigger regions 152, 154 are active and may be used to configure a data reading function of the electronic device 100 by applying a control gesture 200. However, when the electronic device 100 is in a second orientation (e.g., a landscape layout-not shown), the edge trigger regions 152, 154 may be in an inactive state such that any control gesture applied while the device 100 is in the second orientation will not be registered and have no impact on configuring a functionality of the electronic device 100. In some embodiments, the tilt sensor or accelerometer 142 detects the orientation of the electronic device 100 to determine the active/inactive status of the edge trigger regions 152, 154. In other embodiments, other sensors or suitable systems may detect the orientation of the electronic device 100.

In some embodiments, the display controller 110 may be in communication with the accelerometer 142. When the electronic device 100 is tilted or rotated, the accelerometer 142 may send a signal to the display controller 110 to alter a visual state of the edge trigger regions 152, 154 based on the detected orientation of the electronic device 100. For example, the edge trigger regions 152, 154 may have an altered visual state (e.g., displayed in a red color) as displayed on the touch screen 112 when the electronic device 100 is in the second orientation as compared to the corresponding visual state of the edge trigger regions 152, 154 when the electronic device 100 is in the first orientation (e.g., displayed in a green color) to indicate to the user whether the edge trigger regions 152, 154 are operational and can be used for configuring a selected data reading functionality of the electronic device 100. In some embodiments, the edge trigger regions 152, 154 may appear on the touch screen 112 in different colors as described, or may be transparent or invisible when the electronic device 100 is in the second orientation to quickly indicate to the user that the edge trigger regions 152, 154 are in an inactive state.

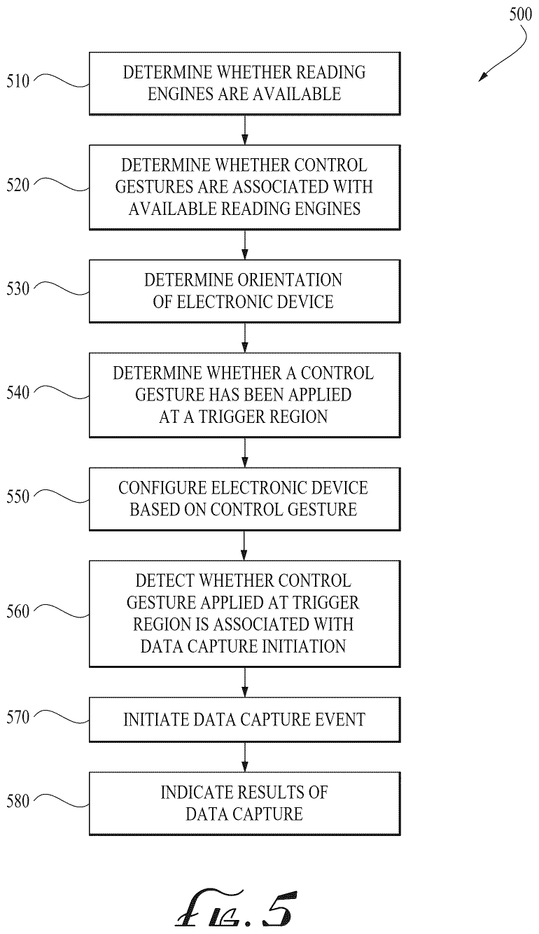

FIG. 5 is a flow chart illustrating a method 500 for data reading by the electronic device 100 according to one embodiment. With reference to FIG. 5, at step 510, the electronic device 100 determines whether one or more reading engine(s) 102 are available for the electronic device 100. The reading engines 102 may be configured with decoding parameters and filters as desired that may be stored in memory 116 or other suitable databases. The various decoding parameters and filters may be associated with specific reading engines 102 being configured and used, such as an optical barcode scanning engine or an RFID reading engine, or other suitable data reading engines. In some embodiments, the decoding parameters and filters may include one or more of the following: instructions for length of time to spend on decoding 1D and 2D labels and or RFID tags, instructions for reading data of a specific length, instructions for minimum and maximum acceptable length for 1D and 2D labels and RFID tags, parameters relating to label/tag prefix and postfix, decoding aggressiveness, RFID classes and other traditional symbology and/or RFID tag characteristics. These instructions may vary for each of the different reading engines 102 based on, for instance, the inherent limitations and characteristics of each data type.

Once the electronic device 100 has determined that decoding parameters for the reading engine(s) 102 are available and accessible to the electronic device 100, at step 520, the electronic device 100, via the processing unit 104, determines whether corresponding control gestures are associated with the available reading engine(s) 102. In some embodiments, the control gestures associated with enabling the reading engines 102 may be stored in memory 116 or stored on a remote system accessible to the electronic device 100. As mentioned previously, configuring and/or activation of the reading engines 102 (e.g., 1D, 2D, RFID engines, or other decoding engines) are associated with a control gesture 200 being applied to one of the edge trigger regions 152, 154. The control gestures 200 allow an operator of the electronic device 100 to select a reading engine 102 (and an associated set of decoding parameters) by applying a control gesture 200 along one of the edge trigger regions 152, 154.

At step 530, the electronic device 100, such as via the tilt sensor or accelerometer 142 (and the processing unit 104) determines an orientation of the device 100. As noted previously, in some embodiments, the edge trigger regions 152, 154 may only be active when the electronic device 100 is in a first orientation (e.g., a portrait layout) but not when the electronic device 100 is in a second orientation (e.g., a landscape layout). In some embodiments, the position of the edge trigger regions 152, 154 may change depending on the orientation. As a result, the edge trigger regions 152, 154 may be proximate respective peripheral edges 156, 158 when held in portrait layout, but may change location to the top/bottom peripheral edges when held in landscape layout so that they remain on the left and right edges from the perspective of the user. In some embodiments, step 530 may be omitted and the electronic device 100 may operate regardless of orientation. In such an embodiment, the edge trigger regions 152, 154 may be remain located proximate the same peripheral edges regardless of orientation, such that (from the perspective of the user) they would be on the left and right edges in portrait layout and on the top and bottom edges in landscape layout.

At step 540, the electronic device 100 detects or determines whether a control gesture 200 has been applied to the touch screen 112 at a location where one of the edge trigger regions 152, 154 is displayed. In some embodiments, the display controller 110 and/or the processing unit 104 may be configured to determine whether a stylus instrument, a finger, or other pointing device has contacted the touch screen 112.

The display controller 110 and/or processing unit 104 may be programmed to ignore intermittent or incidental contact (e.g., constant contact is not maintained for a minimum time threshold) with the touch screen 112. In some embodiments, to simplify use of the electronic device 100, the touch screen 112 may include a legend or other feature visible to the operator with information regarding the control gestures 200 for configuring and/or activating the reading engine(s) 102 and initiating a data read or scan event. In some embodiments, prior to applying a control gesture 200, the user may consult the legend or review control gesture options displayed on the touch screen 112 to ensure that the desired option is being applied.

In some embodiments, the touch screen 112 may present a prompt to the operator allowing the operator to confirm or deny that the selection was properly made or received by the electronic device 100. In some instances, the operator may have erroneously applied a control gesture for a different reading engine 102 or selected a different data reading functionality than intended. In other instances, the data reader 100 may have misinterpreted the applied control gesture and called up the incorrect reading engine 102. In any case, if the desired mode is not selected and the operator does not wish to continue with the selected settings, the operator may communicate to the electronic device 100 that the desired mode was not selected and thereafter re-apply the control gesture along one of the edge trigger regions 152, 154 to select new settings.

Once the electronic device 100 detects or determines that a control gesture 200 has been applied, the display controller 110 and/or processing unit 104 may communicate with the memory 116, interface 122, connector 109, or other system (e.g., a remote computer) to determine whether the detected control gesture corresponds with instructions for selecting a reading engine 102 and/or other data reading functionality of the electronic device 100. At step 550, the processing unit 104 determines the reading engine 102 that corresponds with the applied control gesture at the selected edge trigger region 152, 154 and configures the electronic device 100 accordingly.

At step 560, the portable electronic device 100 determines whether a control gesture 200 has been applied at any of the edge trigger regions 152, 154 to initiate a data capture event (e.g., an optical code read). As noted above, the control gesture 200 may be a swipe gesture starting at the edge and moving inward. Different actions may also be initiated depending on the type of swipe gesture (e.g., short swipe, swipe-and-press, etc.). In some embodiments, as noted previously, the electronic device 100 may already be set with a preprogrammed reading engine and the control gesture 200 applied at the edge trigger region 152, 154 may simply initiate a data read or scan event via the electronic device 100. Accordingly, in such embodiments, the method 500 may omit some or all of steps 510, 520, 540, and 550.

At step 570, the electronic device 100 initiates the data capture event. In some embodiments, the specific functionality associated with the data capture event may be based on the control gesture applied as previously noted. For example, one control gesture may result in the electronic device 100 attempting to capture data for a predetermined period of time. Another control gesture may result in the electronic device 100 continuously attempting to capture data until another control gesture is applied.

At step 580, the electronic device 100 indicates the results of the data capture event (e.g., whether a read was successful or unsuccessful). In some embodiments, the electronic device 100 may emit a beeping sound or other good/bad read tone or may alter a color/appearance of the edge trigger regions 152, 154, and/or display a message on the 112 alerting the operator of the read status. If the read was unsuccessful, the method may revert back to step 560 or any of the previous steps to reattempt the read. If the read was successful, the portable electronic device 100 decodes the captured data from the item being processed. Thereafter, the electronic device 100 may store the decoded data in any suitable medium, such as in memory 116, in internal hard drive 124, on an external input device 107, or may instead send the decoded data to another computer or device in communication with the electronic device 100.

It should be understood that while the steps in the method are presented and described in a particular order, the order is for convenience only and is not meant to be limiting. In some embodiments, the steps may be performed in an order different than what is specified herein. In addition, the method may include additional steps and features other than those included herein. In some embodiments, the method may combine certain steps or omit certain steps altogether, as noted in some examples above. As another example, in other embodiments, the method 500 may omit various steps and include only steps 530, 560, and 570. In still other embodiments, the method 500 may include only steps 560 and 570.

The terms and descriptions used above are set forth by way of illustration only and are not meant as limitations. Those skilled in the art will recognize that many variations can be made to the details of the above-described embodiments without departing from the underlying principles of the invention.

1. An electronic device comprising:
a housing adapted for handheld operation, the housing including a first peripheral edge and a second peripheral edge opposite one another, and a third peripheral edge and a fourth peripheral edge opposite one another;
a touch screen supported on the housing and configured to display information thereon, the touch screen including one or more sensors configured to detect an application of a control gesture on the touch screen, the touch screen having a first edge trigger region graphically depicted thereon and adjacent one of the first peripheral edge, the second peripheral edge, the third peripheral edge, or the fourth peripheral edge of the housing, and wherein the control gesture includes a gesture detected by the one or more sensors from the first edge trigger region toward a central region of the touch screen;
a data reader operable for capturing data from one or more items; and
a processing subsystem in communication with the data reader and the one or more sensors of the touch screen, wherein, in response to detecting application of the control gesture at the first edge trigger region, the processing subsystem configures and activates the data reader to initiate a reading functionality of the electronic device and capture data from the one or more items, wherein the control gesture includes a swipe gesture detected by the one or more sensors as starting at a respective peripheral edge and moving toward an inner area of the touch screen.

2. The electronic device of claim 1, wherein in response to detecting the control gesture applied on the touch screen at the first edge trigger region, the processing subsystem configures and activates the data reader for capturing data from the one or more items until a predetermined amount of time has elapsed.

3. The electronic device of claim 1, wherein the reading functionality is initiated responsive to the swipe gesture being detected by the one or more sensors as being substantially perpendicular relative to the corresponding first peripheral edge, the second peripheral edge, the third peripheral edge, or the fourth peripheral edge at which the first edge trigger region is located.

4. The electronic device of claim 1, wherein the processing subsystem is configured to initiate different actions depending on both an angle and direction of the swipe gesture detected by the one or more sensors relative to the corresponding first peripheral edge, second peripheral edge, third peripheral edge, or fourth peripheral edge at which the first edge trigger region is located.

5. The electronic device of claim 4, wherein the data reader is configurable with any one of a plurality of operating parameters, and wherein the processing subsystem selectively configures the data reader with a selected operating parameter from the plurality of operating parameters responsive to a measurement of the angle of the swipe gesture as detected by the one or more sensors of the touch screen.

6. The electronic device of claim 1, wherein in response to detecting the control gesture applied on the touch screen at the first edge trigger region, the data reader is configured to continuously capture data from the one or more items until the control gesture is no longer detected on the touch screen by any of the one or more sensors.

7. The electronic device of claim 1, wherein the first peripheral edge includes a left side of the housing, the second peripheral edge includes a right side of the housing, the third peripheral edge includes a top side of the housing, and the fourth peripheral edge includes a bottom side of the housing.

8. The electronic device of claim 1, further comprising a second edge trigger region offset from the first edge trigger region, the second edge trigger region graphically depicted on the touch screen and adjacent another one of the first peripheral edge, the second peripheral edge, the third peripheral edge, or the fourth peripheral edge, and wherein, in response to detecting application of the control gesture at the second edge trigger region, the processing subsystem configures and activates the data reader to capture data from the one or more items, and wherein the processing subsystem configures the data reader with a first operating parameter in response to detecting application of the control gesture at the first edge trigger region, and wherein the processing subsystem configures the data reader with a second operating parameter different from the first operating parameter in response to detecting application of the control gesture at the second edge trigger region.

9. (canceled)

10. The electronic device of claim 1, wherein the data reader is configurable with any one of a plurality of operating parameters, and wherein the processing subsystem selectively configures the data reader with a selected operating parameter from the plurality of operating parameters responsive to one or more pattern characteristics associated with the applied control gesture as detected by the one or more sensors at the first edge trigger region, wherein the one or more pattern characteristics include a length of the swipe gesture applied on the touch screen, a single touch or a multi-touch sequence applied on the touch screen, or a length of time of a continuous touch applied on the touch screen.

11. (canceled)

12. The electronic device of claim 8, wherein the first edge trigger region and the second edge trigger region are semi-transparent as graphically displayed on the touch screen so as to partially obscure information displayed on the touch screen over which the first edge trigger region or the second edge trigger region is overlaid.

13. The electronic device of claim 1, further comprising an accelerometer coupled to the housing and configured to detect the electronic device at a first orientation and at a different second orientation and cause the first edge trigger region to be active only with the electronic device in the first orientation and inactive when the electronic device is in the second orientation such that the processing subsystem configures and activates the data reader to capture data from the one or more items when detecting application of the control gesture at the first edge trigger region when the electronic device is at the first orientation but not when at the second orientation.

14. A method of capturing data with an electronic device having a touch screen with a first edge trigger region, the method comprising:
displaying, on the touch screen, a graphical depiction of the first edge trigger region adjacent a first peripheral edge, a second peripheral edge, a third peripheral edge, or a fourth peripheral edge of the touch screen;
detecting, via one or more sensors, an application of a control gesture at the first edge trigger region, wherein the control gesture includes a swipe gesture detected by the one or more sensors from the first edge trigger region toward a central region of the touch screen;
configuring, via a processing subsystem, a data reader with one or more operating parameters responsive to the control gesture applied at the first edge trigger region; and
capturing, via the data reader, encoded data from an item located external to the electronic device.

15. (canceled)

16. (canceled)

17. The method of claim 14, further comprising:
receiving, via the processing subsystem, display instructions altering a position and/or a graphical appearance associated with the first edge trigger region; and
displaying, via the touch screen, the first edge trigger region on the altered position and/or graphical appearance.

18. The method of claim 14, further comprising detecting, via an accelerometer, an orientation of the touch screen relative to the item, wherein the touch screen is movable between a first orientation and a second orientation, and wherein the step of capturing, via the data reader, encoded data from the item occurs only when the touch screen is in the first orientation but not the second orientation.

19. The method of claim 14, wherein the step of capturing, via the data reader, encoded data continues until a predetermined amount of time has elapsed.

20. The method of claim 14, wherein the step of capturing, via the data reader, continues until the control gesture is no longer detected on the touch screen.

21. The electronic device of claim 1, wherein the graphical depiction of the first edge trigger region has a greater dimension along a peripheral edge that tapers inward toward the inner area of the touch screen.

22. The electronic device of claim 1, wherein the swipe gesture detected in a substantially perpendicular line from the respective peripheral edge toward the inner area initiates the reading functionality and data capture, and detecting the swipe gesture in an oblique line form the respective peripheral edge toward the inner area initiates a different action by the electronic device.

23. The electronic device of claim 1, wherein detecting the swipe gesture to have a different duration initiates different reading functionality and data capture actions by the electronic device.

24. The electronic device of claim 23, wherein if the swipe gesture is a short swipe having a shorter duration, a data reading period is triggered until a predetermined timeout period has elapsed, and wherein if the swipe gesture is a longer swipe having a longer duration, a continuous data reading period is triggered until a touch of the swipe gesture is released.
